(19) United States
(12) Patent Application Publication
(10) Pub. No.: US 2011/0293822 A1
(43) Pub. Date: Dec. 1, 2011

(54) METHOD AND APPARATUS FOR PREPARING A POLARIZING DYE RECEIVING SURFACE

(76) Inventors: Jerome Vivien Davidovits, Thomery (FR); Eric Gesell, Chaintreaux (FR)

(21) Appl. No.: 12/789,759

(22) Filed: May 28, 2010

(51) Int. Cl. B05D 5/06; B24B 7/04; B24B 13/00; B24B 1/00

(52) U.S. Cl. 427/163.1; 451/59; 451/37; 451/178; 451/246

(57) ABSTRACT

A method of preparing a polarizing dye receiving surface includes bringing the polarizing dye receiving surface into contact with a brushing surface of a brush pad carrying an abrasive material and brushing the polarizing dye receiving surface with the brushing surface in one or more brushing strokes. Each brushing stroke comprises effecting a unidirectional relative motion between the polarizing dye receiving surface and the brushing surface along a brushing path. The polarizing dye receiving surface is separated from the brushing surface after the brushing.

### BACKGROUND

1. Field of the Invention

The invention relates generally to the manufacture of polarizing articles by depositing polarizing dyes on surfaces. More specifically, the invention relates to a method of preparing a surface to receive a polarizing dye.

2. Description of Related Art

Methods of manufacturing polarizing articles by depositing polarizing dyes on surfaces of substrates (or surfaces of intermediate layers attached to substrates) are known. See, for example, U.S. Pat. Nos. 2,400,877 (John F. Dreyer), 4,977,028 (Goepfert et al.), 4,683,153 (Goepfert et al.), and 7,625,626 (Bear et al.), and International Publication No. WO 2005/050265 (Corning Incorporated). In these methods, the polarizing dyes are typically nematic phase liquid crystals. The surfaces are brushed with an abrasive material prior to depositing the nematic phase liquid crystals on them. Brushing has the effect of preparing the surfaces to receive the nematic phase liquid crystals. For instance, brushing results in tiny grooves, typically at the sub-micron level, on the surfaces. U.S. Pat. No. 4,977,028 (Goepfert et al.) describes brushing of a surface using a thick rotary disc impregnated with an abrasive slurry. When a nematic phase liquid crystal is deposited on a brushed surface, the nematic molecules align themselves in a direction coinciding with the orientation of the grooves on the brushed surface. Since the polarization effect of the polarizing article depends at least in part on the parallel alignment of the polarization dye molecules, it is desirable that the grooves on the brushed surface are parallel and well-defined.

FIG. 2 shows a prior art apparatus 32 for brushing a concave surface 33 of a substrate 34. The substrate 34 is supported in a holder 35, which has a concave surface 37 shaped to receive the convex surface 36 of the substrate 34. The holder 35 is mounted on a positioning device 41 capable of imparting a linear motion to the holder 35 in the direction indicated by arrow 39. A brush pad 43 is supported in opposing relation to the substrate 34 and holder 35. The brush pad 43 has a spherical brushing surface 49. The brush pad 43 is rotatable along the direction indicated by arrow 45 by a driver 47. To brush the concave surface 33, the positioning device 41 is controlled to move the holder 35 relative to the brush pad 43 until the concave surface 33 of the substrate 34 comes into contact with the spherical surface 49 of the brush pad 43. The positioning device 41 keeps the holder 35 stationary in this position, with the concave surface 33 of the substrate 34 biased against the spherical surface 49 of the brush pad 43. The brush pad 43, which carries an abrasive material, is rotated along the direction indicated by arrow 45, while in contact with the concave surface 33, in order to brush the concave surface 33. The prior art apparatus 32 and its associated method are not able to achieve a homogeneous brushing on a convex surface.

### SUMMARY

In a first aspect of the present invention, a method of preparing a polarizing dye receiving surface comprises bringing the polarizing dye receiving surface into contact with a brushing surface of a brush pad carrying an abrasive material. The method further comprises brushing the polarizing dye receiving surface with the brushing surface in one or more brushing strokes. Each brushing stroke comprises effecting a unidirectional relative motion between the polarizing dye receiving surface and the brushing surface along a brushing path. The method further comprises separating the polarizing dye receiving surface from the brushing surface of the brush pad.

In one embodiment of the first aspect, the method further comprises rotating the brush pad during each brushing stroke so that different areas of the brushing surface contact the polarizing dye receiving surface during the brushing stroke.

In one embodiment of the first aspect, the method further comprises biasing the polarizing dye receiving surface against the brushing surface with a force.

In one embodiment of the first aspect, the brushing surface locally conforms to the polarizing dye receiving surface in response to the force.

In one embodiment of the first aspect, the polarizing dye receiving surface is a convex surface and the brushing surface is a concave surface, and the concave surface has a radius of curvature that is greater than or equal to that of the convex surface.

In one embodiment of the first aspect, the polarizing dye receiving surface is a concave surface and the brushing surface is a convex surface, and the concave surface has a radius of curvature that is less than or equal to that of the concave surface.

In one embodiment of the first aspect, the polarizing dye receiving surface is a planar surface and the brushing surface is a planar surface.

In one embodiment of the first aspect, the brushing path is a circular path.

In one embodiment of the first aspect, the brushing path is defined by a profile of the polarizing dye receiving surface.

In a second aspect of the present invention, a method of making a polarizing article comprises preparing a polarizing dye receiving surface as described in the first aspect of the present invention, followed by depositing a polarizing dye on the polarizing dye receiving surface.

In one embodiment of the second aspect, the polarizing dye is a liquid crystal compound.

In one embodiment of the second aspect, the method further comprises washing the polarizing dye receiving surface to remove the abrasive material from the polarizing dye receiving surface prior to depositing the polarizing dye on the polarizing dye receiving surface.

In one embodiment of the second aspect, the polarizing dye receiving surface is a curved surface.

In one embodiment of the second aspect, the polarizing dye receiving surface is a surface of an ophthalmic lens or a sunglass lens.

In a third aspect of the present invention, an apparatus for brushing a polarizing dye receiving surface comprises a brush pad having a brushing surface, where the brush pad carries or is capable of carrying an abrasive material. The apparatus further a holder having a surface for supporting the polarizing dye receiving surface and a positioning device coupled to at least one of the brush pad and the holder to selectively position the holder adjacent to the brush pad. The apparatus further comprises a first driver coupled to the brush pad. The first driver is configured to rotate the brush pad so that different areas of the brushing surface can be positioned adjacent to the holder. The apparatus further comprises a second driver coupled to the holder. The second driver is configured to move the holder in order to effect a relative motion between the holder and the brushing surface along a brushing path.

In one embodiment, the second driver is configured to rotate the holder in order to effect the relative motion.

In one embodiment of the third aspect, the brushing surface has a profile selected from the group consisting of a convex profile, a flat profile, and a concave profile.

Other aspects of the present invention will be apparent from the following description and the appended claims.

### BRIEF DESCRIPTION OF DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 is a schematic of an apparatus for preparing a polarizing dye receiving surface.

FIG. 2 is a schematic of a prior art apparatus for brushing a concave surface.

FIG. 3A is a front view of brush pad geometry having a convex profile.

FIG. 3B is a cross-section of FIG. 3A along line 3B-3B.

FIG. 4A is a front view of a brush pad geometry having a flat profile.

FIG. 4B is a cross-section of FIG. 4B along line 4B-4B.

FIG. 5A is a front view of a brush pad geometry having a concave profile.

FIG. 5B is a cross-section of FIG. 5A along line 5B-5B.

FIG. 6 is an image of a polarizing glass lens formed according to Example A.

FIG. 7 is an image of a polarizing glass lens formed according to Example B.

FIG. 8 is an image of a polarizing glass lens formed according to Example C.

FIG. 9 is an image of a polarizing glass lens formed according to Example D

### DETAILED DESCRIPTION

In the following detailed description, numerous specific details may be set forth in order to provide a thorough understanding of embodiments of the invention. However, it will be clear to one skilled in the art when embodiments of the invention may be practiced without some or all of these specific details. In other instances, well-known features or processes may not be described in detail so as not to unnecessarily obscure the invention. In addition, like or identical reference numerals may be used to identify common or similar elements.

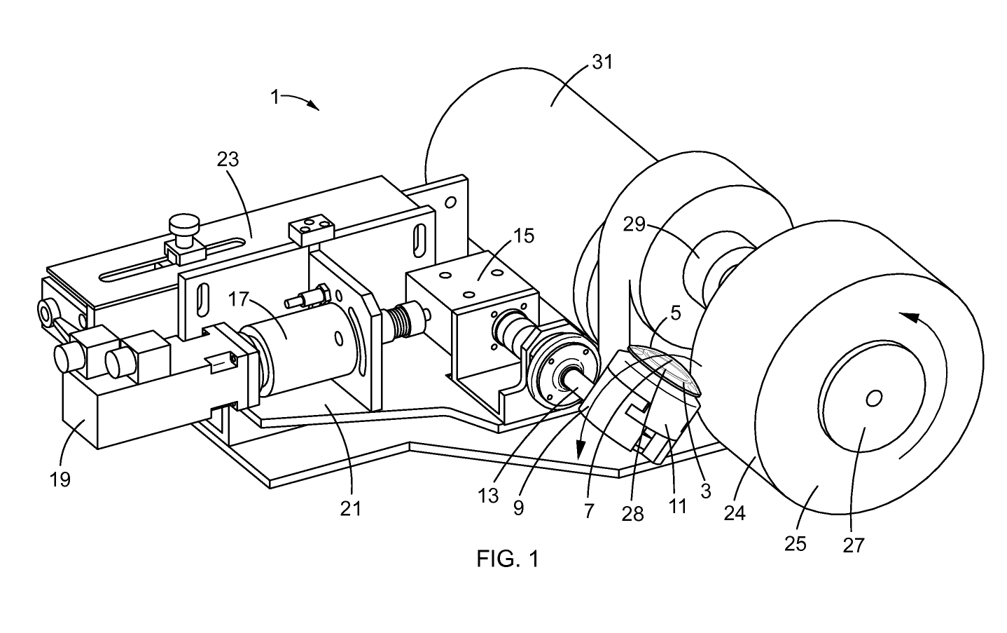

FIG. 1 depicts brushing of a surface of a substrate 3 using apparatus 1. The surface of the substrate 3 is being brushed in preparation for polarization dye deposition. In one or more embodiments, the substrate 3 is a light-transmitting substrate. The substrate 3 may be made of an organic or inorganic material. The substrate 3, if made of an organic material, may be coated with an inorganic material, e.g., silica, as described in U.S. Pat. No. 7,625,626. In some embodiments, the substrate 3 may be made of glass or polymer. In some embodiments, the substrate 3 may be a lens. The lens may be suitable for ophthalmic applications, high power lens applications, low power lens applications, and solar applications. In other embodiments, the substrate 3 may be a substrate for applications such as optical windows or filters. In certain embodiments, the substrate 3 is a sunglass lens or an ophthalmic lens. In FIG. 1, the substrate 3 has two curved surfaces—a concave surface 5 and a convex surface 7, the convex surface 7 being in opposing relation to the concave surface 5. The curved surfaces may be simple, e.g., defined by a sphere or cylinder, or complex, e.g., defined by an asphere or by a continuous or multi-patch geometric spline. The surfaces 5, 7 may be symmetric or asymmetric. For opthalmic applications, the curved surfaces may be selected from progressive, aspherical, spherical, and cylindrical surfaces. In certain embodiments, the substrate 3 is a flat surface.

The substrate 3 is supported on a holder 9 of brushing apparatus 1. The holder 9 may have a surface shaped to mate with a surface of the substrate. In FIG. 1, for example, the holder 9 has a conical surface 11 shaped to mate with the concave surface 5 of the substrate 3. The substrate 3 may be retained on the holder 9 via a variety of means. For example, the substrate 3 may be retained on the holder 9 by vacuum. In one example, a hole is cut in the conical surface 11 of the holder 9. The hole is connected to an internal cavity of the holder 9, and an elastomeric O-ring is set in the hole. To retain the substrate 3 on the holder 9, vacuum is applied to the concave surface 5 of the substrate 3 through the internal cavity and hole. The applied vacuum draws the concave surface 5 of the substrate 3 against the O-ring set in the hole on the conical surface 11 of the holder 9, where the O-ring serves to seal in between the concave surface 5 of the substrate 3 and the conical surface 11 of the holder 9. In another example, the substrate 3 may be retained on the suitably shaped surface 11 of the holder 9 by an adhesive, which can be later removed to separate the substrate 3 from the holder 9.

The holder 9 is mounted on a support shaft 13. The support shaft 13 is coupled to a holder drive system including a bevel gear box 15, a reduction box 17, and a drive motor 19 with associated electronics. The drive motor 19 may be a brushless motor. In general, any suitable gearing arrangement and drive motor may be used in the holder drive system. The gear box 15, reduction box 17, and drive motor 19 are mounted on a frame 21, which is attached to a positioning device 23. The positioning device 23 may be a linear slide or actuator, for example. The holder drive system (15, 17, 19) can be operated to rotate the support shaft 13 and the holder 9 about an axis coincident with the axial axis of the support shaft 13. The apparatus 1 includes a brush pad 25 mounted on a spindle 27. The spindle 27 is coupled to a drive motor 31 via a journal bearing 29. The drive motor 31 can be operated to rotate the spindle 27 and the brush pad 25 about an axis coincident with the axial axis of the spindle 27. The axial axes of the support shaft 13 and spindle 27 will generally be parallel to each other when a surface of the substrate 3 is being brushed. The positioning device 23 can move the entire holder assembly (9, 13, 15, 17, 21) along an axis that is transverse to the axial axis of the spindle 27. In this manner, the positioning device 23 will be operable to translate the holder 9 relative to the brush pad 25 so that a surface of the substrate 3 mounted on the holder 9 can be selectively positioned in contact with a brushing surface 24 of the brush pad 25. Alternatively, the brush pad assembly (31, 29, 27, 25) may be mounted to a frame, and the frame may be attached to a positioning device so that it is the brush pad 25 that is translatable relative to the holder 9 in order to make establish contact between a surface of the substrate 3 mounted on the holder 9 and the brushing surface 24.

The brush pad 25 carries an abrasive material, typically in loose form. The abrasive material may be an inorganic material such as zirconia or alumina. The abrasive material may be provided in a slurry, e.g., zirconia or alumina powder suspended in water. Typical mean particle size for the powdered abrasive material in the slurry may be in a range from 0.5 μm to 20 μm. The brush pad 25 can be loaded with the abrasive material by dipping or soaking the brush pad 25 in the abrasive slurry. This would require that the brush pad 25 is capable of holding onto the abrasive material. For this purpose, the brush pad 25, or at least the brushing surface 24 of the brush pad 25, may be made of a foam, porous, fabric, or felt material. The brush pad 25, or at least the brushing surface 24 of the brush pad 25, may be made of a conformable material so that the brushing surface 24 can locally conform to the surface being brushed as necessary. It is noted that a foam, porous, fabric, or felt material would generally meet the requirement of a conformable material. Suitable brush pad materials are porous polymers such as polyester, polyether, or polyurethane.

The brushing procedure will now be described. The brush pad 25, carrying an abrasive material as described above, is set to rotate at a selected speed, e.g., by rotating the spindle 27. For example, the brush pad 25 may be rotated at a speed between 300 rpm and 450 rpm. The convex surface 7 is brought into contact with the brushing surface 24 of the brush pad 25, e.g., using the positioning device 23, or vice versa. It should be noted that the convex surface 7 is used here as an example of the surface of the substrate 3 to be brushed, i.e., the brushing procedure described here applies when the surface to be brushed is not convex and regardless of the complexity of the surface to be brushed. With the brushing surface 24 in contact with the convex surface 7, the convex surface 7 is brushed in one or more brushing strokes to form grooves in the brushed surface. After brushing, the convex surface 7 is separated from the brushing surface 24, e.g., using the positioning device 23. Deposition of polarizing dye on the brushed surface typically follows within a few minutes of brushing to achieve the best polarization results.

During each brushing stroke, a relative motion is effected between the convex surface 7 and the brushing surface 24 along a brushing path. The relative motion along the brushing path is unidirectional. This effecting of relative motion will be explained further by means of an example. In FIG. 1, the holder 9 may be rotated along a circular path (by rotating the support shaft 13) in a counterclockwise direction. This rotation of the holder 9 will result in rotation of the convex surface 7 along a circular path in the counterclockwise direction. Thus, the convex surface 7 can be described as moving relative to the brushing surface 24 along a circular path in a counterclockwise direction. It is also possible for the convex surface 7 to move relative to the brushing surface 24 along a circular path in a clockwise direction, e.g., by rotating the holder 9 along a circular path in a clockwise direction. In this example, the circular path represents the brushing path. However, the relative motion effected during a brushing stroke is not limited to being along a brushing path that is circular. The brushing path may be non-circular in other embodiments. The brushing path may be defined by a profile of the convex surface 7 (or a profile of the surface being brushed). For example, if the convex surface 7 (or the surface being brushed) is aspherical, then the brushing path can be suitably selected to be an aspherical path.

It was mentioned above that the relative motion effected during a brushing stroke is unidirectional along a brushing path. Considering the example above again, what this means is that during each brushing stroke, the convex surface 7 (or, in general, the surface being brushed) can either move in a clockwise direction or a counterclockwise direction, but not in both directions. However, if the convex surface 7 moves in a counterclockwise direction in one brushing stroke, it is perfectly acceptable for the convex surface 7 to move in a clockwise direction in another brushing stroke. That is, changes in direction of relative motion is permissible between brushing strokes, but not within a brushing stroke. Again, the terms “clockwise” and “counterclockwise” may not make much sense when the brushing path is non-circular. Therefore, what should be kept in mind is that “unidirectional” means no reversals in direction of the relative motion along the brushing path during a brushing stroke.

During each brushing stroke, the convex surface 7 (or, in general, the surface being brushed) is completely brushed. That is, the brushing surface 24 does not stop in the middle of the convex surface 7 during a brushing stroke, but rather moves from one end of the convex surface 7 to another end of the convex surface 7 so that grooves formed on the convex surface 7 are all oriented in the same direction.

During each brushing stroke, the positioning device 23 acts to bias the convex surface 7 (or, in general, the surface being brushed) against the brushing surface 24, resulting in a reaction force against the convex surface 7 by the brushing surface 24. This reaction force is slight but sufficient to allow the abrasive material carried on the brushing surface 24 to alter the surface being brushed to a form desirable for polarization dye deposition. This alteration includes, but is not limited to, forming grooves on the brushed surface. The grooves are typically at the sub-micron level. If the brushing surface 24 is conformable, the reaction force may also serve to locally conform the brushing surface 24 to the convex surface 7 (or, in general, the surface being brushed) so that the convex surface 7 is completely brushed with the abrasive material even if the convex surface 7 is a complex surface. The reaction force can be increased or decreased by adjusting the relative positioning of the substrate 3 to the brush pad 25. It should be noted that brushing of a surface will only last for a few seconds, typically less than 60 seconds. That is, the brushing time will not be sufficient to result in polishing of the brushed surface.

The brushing method described above also applies to non-convex surfaces, e.g., concave surfaces. For example, the apparatus 1 may also be used to brush the concave surface 5 of the substrate 3. For the apparatus 1 to be used in brushing the concave surface 5 of the substrate 3, a few changes may need to be made to the apparatus. For example, the substrate 3 would have to be supported so that the concave surface 5 faces the brushing surface 24 of the brush pad 25. This may require a different holder than holder 9. For example, such a different holder may have a concave surface shaped to mate with the convex surface 7 of the substrate 3. Another change that could be made is to the brush pad 25. The brush pad 25 may be replaced with another brush pad that has a brushing surface geometry better suited for brushing a concave surface. Examples of different brushing surface geometries will be explained below. The brushing method described above could also be applied to brushing of multiple surfaces in a single process. For this, some adaptations of the apparatus 1 would also be necessary. For example, the holder 9 that now accepts one substrate at a time can be replaced with a holder that has multiple mounting surfaces for substrates. The new holder may be in the form of a wheel, which may be mounted on the support shaft 13. By rotating the wheel in front of the brushing surface 24 of the brush pad 25, it will be possible to brush the surfaces of multiple substrates mounted on the holder with the brushing surface 24 in a single process.

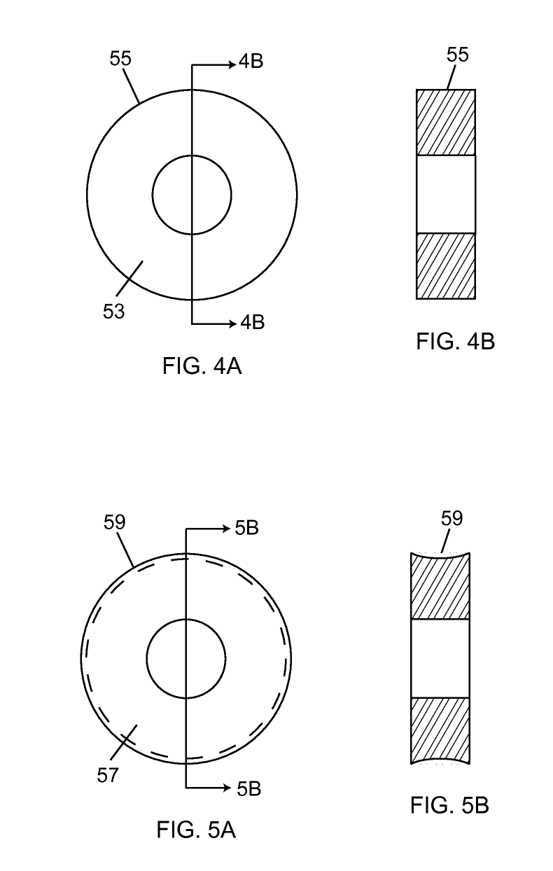

The brush pad 25 in FIG. 1 used with the apparatus 1 in FIG. 1 is wheel-shaped and can have a variety of circumferential surface geometries. It is the circumferential surface of the brush pad that contacts the surface of the substrate and that is referred to as the brushing surface above. FIG. 3A is a front view of a brush pad geometry 50, and FIG. 3B is a cross-section of FIG. 3A along line 3B-3B. FIGS. 3A and 3B show the brush pad geometry 50 as having a brushing surface 51 that is convex (FIG. 3B). The brush pad geometry 50 can be formed by cutting out a symmetrical slice from a spherical brush pad material. The radius of curvature of the brushing surface 51 may be equal to or slightly smaller than the radius of curvature of the surface to be brushed. The brushing surface 51 can be used to brush concave surfaces. FIG. 4A is a front view of a brush pad 53, and FIG. 4B is a cross-section of FIG. 4A along line 4B-4B. FIGS. 4A and 4B show the brush pad geometry 53 as having a brushing surface 55 that is flat (FIG. 4B)—that is, the brush pad geometry 53 looks like a regular cylinder. The brushing surface 55 can be used to brush convex surfaces. FIG. 5A is a front view of a brush pad geometry 57, and FIG. 5B is a cross-section of FIG. 5A along line 5B-5B. FIGS. 5A and 5B show the brush pad geometry 57 as having a brushing surface 59 that is concave (FIG. 5B). The radius of curvature of the brushing surface 59 may be equal to or slightly greater than the radius of curvature of the surface to be brushed. The brushing surface 59 can be used to brush convex surfaces. A brush pad having a planar brushing surface may also be used with the apparatus in FIG. 1 when the polarizing receiving dye surface is a planar surface. In this case, it will not be necessary to rotate the planar brushing surface while brushing. However, unidirectional relative motion between the planar brushing surface and the planar surface being brushed would still occur during a brushing stroke.

The brushing method described above is suitable for preparing curved surfaces, convex or concave, simple or complex, for polarization dye deposition. It should be noted that the effectiveness of the brushing method described above with reference to FIG. 1 does not lie merely in selecting a brush pad having a brushing surface that has the same shape as that of the surface to be brushed. The effectiveness of the brushing method lies largely in the manner in which the brushing strokes are carried out as described above. The conforming ability of the brush pad makes it possible to use any brush pad geometry with the surface being brushed. However, to minimize how much the brush pad has to deform to conform to the surface being brushed, it may be helpful to start with a brush pad geometry that is close to that of the surface being brushed.

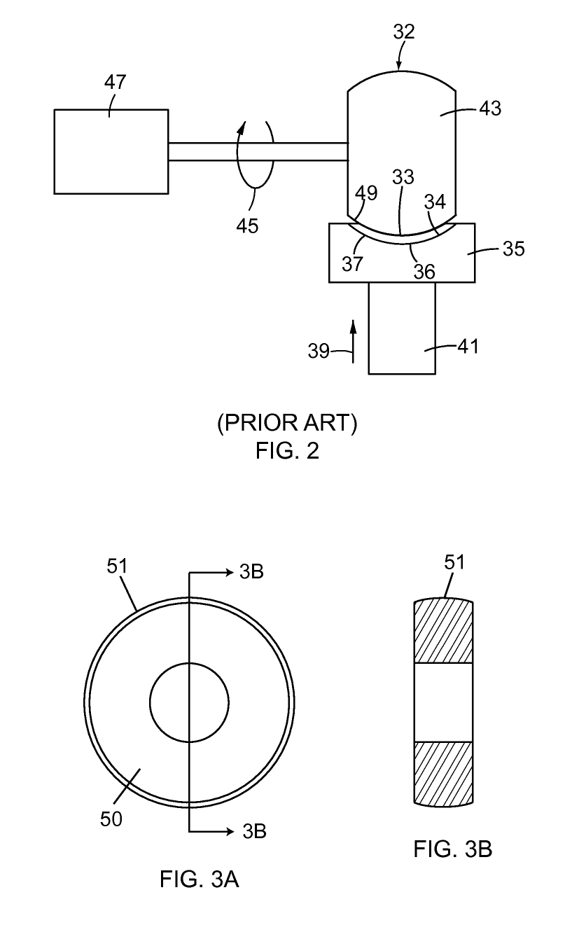

The method of brushing surfaces described above will now be put into the context of making a polarizing article. To make a polarizing article, a substrate suitable for the application is first obtained. The substrate has two opposing surfaces separated by a thickness of substrate material. For illustration purposes, a substrate having a convex surface and a concave surface in opposing relation is obtained. The convex and concave surfaces may be brushed using the apparatus of FIG. 1. Alternatively, the convex surface may be brushed using the apparatus of FIG. 1 and the concave surface may be brushed using the prior art apparatus of FIG. 2. After the surfaces are brushed, a polarizing dye is deposited on the surfaces. The deposition process involves several phases. The surfaces are washed to remove any residues from the loose abrasive material used in brushing the surfaces. Washing can be accomplished using the apparatus of FIG. 1 or the prior art apparatus of FIG. 2, but with water as the brushing medium, i.e., as opposed to an abrasive slurry. The surfaces may be washed a second time by continuously spraying the surfaces with deionized water while rotating the surfaces. The deionized water may or may not contain a surfactant. The surfaces are dried, for example, using infrared heat. The substrate is then stabilized to a predetermined temperature and humidity, e.g., room temperature and humidity. Following this step, the polarizing dye is deposited on the surfaces, typically on one surface at a time, using a process such as spin coating, dip coating, or flow coating. The polarizing dye may be any liquid crystal compound having polarizing properties. The liquid crystal compound may be of the nematic type and may be made of a mixture of liquid crystals. A suitable example of a polarization dye is an azoic dye compound. A non-ionic surfactant or an anionic surfactant may be added to the polarizing dye to assist in forming an ordered or organized phase. After the polarizing dye is deposited on the surfaces, the polarizing layers are stabilized. Typically, this involves immersing the coated substrate in an aqueous solution of inorganic salts having an acid pH. The substrate with the polarizing layers is finally rinsed. In lieu of forming the polarizing layers on both sides of the substrate, the polarizing layer may be formed on only one side of the substrate, either the convex side or the concave side. Additional processes may be carried out to finish the polarizing article. For example, an optical layer or protective layer may be applied on the polarizing layer(s).

The following examples are presented for illustration purposes only and are not intended to limit the invention as otherwise described above or claimed below.

### Example A

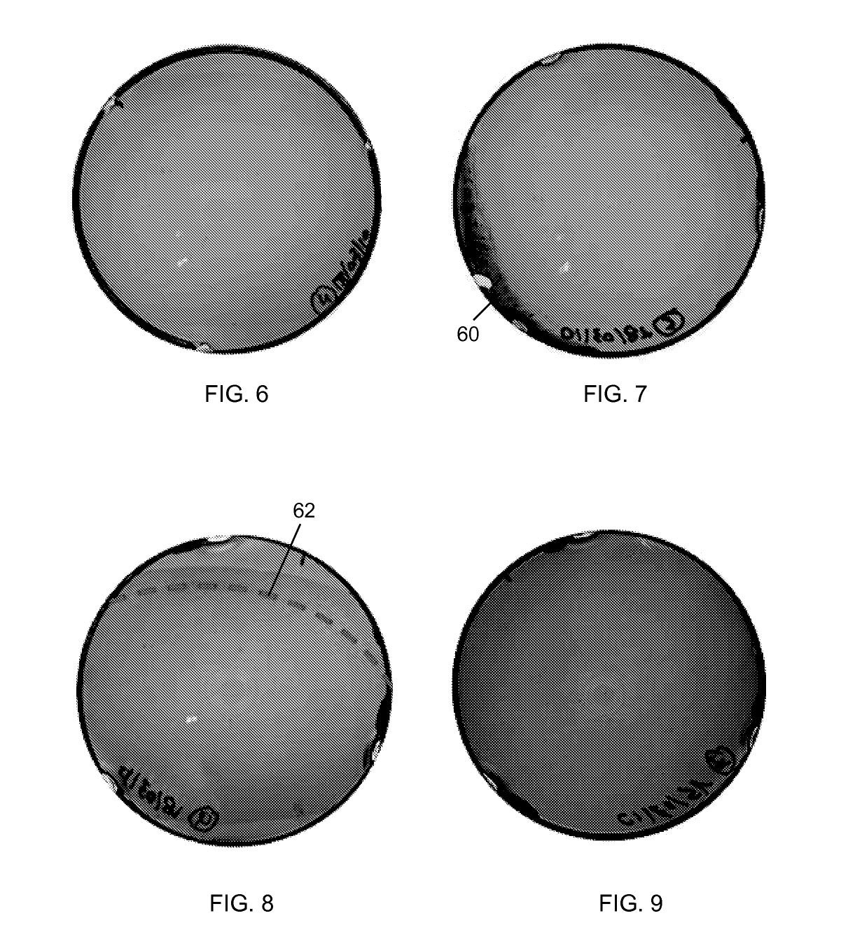

The concave side of a mineral glass lens was brushed using a brush pad having the geometry shown in FIGS. 3A and 3B. The brush pad was made of polyether foam and was soaked in water-based alumina slurry prior to use. The concave side of the lens was brushed using the prior art apparatus of FIG. 2. The lens has a lens base 6, with a diameter of 65 mm. The “lens base” simply refers to the front curve of the lens measured in diopters. For example, many sunglasses have a lens base 6. The diameter of the spherical brush was 175 mm. The brush rotated at 339 rpm. The force applied on the lens contacting the brush was 3 kg. The lens was supported in the holder and brought into contact with the brush and held in contact with the brush for 10 seconds. The lens was carefully rinsed with de-ionized water. A commercial dye solution was spin-coated on the concave side of the lens. The dye solution was a mixture of polarization dye solution (PDS) and activator A3070 supplied by Corning SAS, France, with the amount of activator in the mixture being 0.75 wt %. The formation of the polarizing coating was controlled by the evaporation rate of the solvent. In order to protect the water-soluble dye layer, the coated lens was dipped in a stabilization solution (aluminum chloride solution in water) and then rinsed in de-ionized water. After the stabilization treatment, haze, mean transmission, and polarization efficiency were measured. The results are presented in Table 1 below. FIG. 6 shows an image of the glass lens after polarizing dye deposition and stabilization. The image was taken from the convex side of the glass lens.

### Example B

The convex side of a mineral glass lens was brushed using a brush pad having the geometry shown in FIGS. 4A and 4B. The brush pad was made of polyether foam and was soaked in water-based alumina slurry prior to use. The convex side of the lens was brushed using the apparatus of FIG. 1. The lens has a lens base 6, with a diameter of 65 mm. The diameter of the cylindrical brush was 200 mm. The brush rotated at 339 rpm. The force applied on the lens contacting the brush was 3 kg. The lens was supported in the holder such that the apex of the lens faced the brush. The lens was then brought into contact with the brush while the brush was rotating. The holder was not rotated—that is, there was no relative motion effected between the convex side and the brushing surface. The lens contacted the brush surface for 10 seconds before it was moved away from the brush surface. The lens was carefully rinsed with de-ionized water. A commercial dye solution was spin-coated on the convex side of the lens. The dye solution was a mixture of polarization dye solution and activator A3070 supplied by Corning SAS, France, with the amount of activator in the mixture being 0.75 wt %. The formation of the polarizing coating is controlled by the evaporation rate of the solvent. In order to protect the water-soluble dye layer, the coated lens was dipped in a stabilization solution (aluminum chloride solution in water) and then rinsed in de-ionized water. After the stabilization treatment, haze, mean transmission, and polarization efficiency were measured. The results are presented in Table 1 below. FIG. 7 shows an image of the glass lens after polarizing dye deposition and stabilization. The image was taken from the convex side of the glass lens. The large dark area in the images represents a region of the glass lens where there is no observed polarization.

### Example C

The convex side of a mineral glass lens coated was brushed using a brush pad having the geometry shown in FIG. 4. The brush pad was made of polyether foam and was soaked in water-based alumina slurry prior to use. The convex side of the lens was brushed using the apparatus of FIG. 1. The lens has a base 6 with a diameter of 65 mm. The diameter of the cylindrical brush was 200 mm. The brush rotated at 339 rpm. The force applied to the lens contacting the brush was 3 kg. The lens was supported in the holder such that its lower edge faced the brush. The lens was then brought into contact with the brush while the brush was rotating. The holder was rotated counterclockwise at a rate of 0.6°/s until the upper edge of the lens faced the brush. This ended the first brushing stroke. Then, the holder was rotated clockwise at a rate of 0.6°/s until the apex of the lens faced the brush. This ended the second brushing stroke. The convex side wasn't completely brushed during the second brushing stroke. The lens was then backed away from the brush. The lens contacted the brush for 17 seconds. The lens was carefully rinsed with de-ionized water. A commercial dye solution was spin-coated on the convex side of the lens. The dye solution was a mixture of polarization dye solution and activator A3070 supplied by Corning SAS, France, with the amount of activator in the mixture being 0.75 wt %. The formation of the polarizing coating is controlled by the evaporation rate of the solvent. In order to protect the water-soluble dye layer, the coated lens was dipped in a stabilization solution (aluminum chloride solution in water) and then rinsed in de-ionized water. After the stabilization treatment, haze, mean transmission, and polarization efficiency were measured. The results of these measurements are presented in Table 1. FIG. 8 shows an image of the glass lens after polarizing dye deposition and stabilization. The image was taken from the convex side of the glass lens. The dotted line 62 on the image indicates a defect area including a shift in polarization.

### Example D

The convex side of a mineral glass lens was brushed using a brush pad having the geometry shown in FIG. 4. The brush pad was made of polyether foam and was soaked in water-based alumina slurry prior to use. The convex side of the lens was brushed using the apparatus of FIG. 1. The lens has a lens base 6, with a diameter of 65 mm. The diameter of the cylindrical brush was 200 mm. The brush rotated at 339 rpm. The force applied to the lens contacting the brush was 3 kg. The lens was supported in the holder such that its upper edge faced the brush. The lens was then brought into contact with the brush while the brush was rotating and maintained in contact for 20 seconds. The holder was rotated counterclockwise at a rate of 0.2°/s until the lower edge of the lens faced the brush. This ended the sole brushing stroke. The convex side was completely brushed during the brushing stroke. The lens was then backed away from the brush. The lens contacted the brush for 45 seconds. The lens was carefully rinsed with de-ionized water. A commercial dye solution was spin-coated on the convex side of the lens. The dye solution was a mixture of polarization dye solution and activator A3070 supplied by Corning SAS, France, with the amount of activator in the mixture being 0.75 wt %. The formation of the polarizing coating is controlled by the evaporation rate of the solvent. In order to protect the water-soluble dye layer, the coated lens was dipped in a stabilization solution (aluminum chloride solution in water) and then rinsed in de-ionized water. After the stabilization treatment, haze, mean transmission, and polarization efficiency were measured. The results are presented in Table 1 below. FIG. 9 shows an image of the glass lens after polarizing dye deposition and stabilization. The image of the glass lens was taken from the convex side. Note that on the glass lens of FIG. 9, the polarization layer covers the entire surface and is more uniform than the polarization layer of the glass lens of FIG. 7. FIG. 7 corresponds to Example B, which did not involve effecting any relative motion between the convex side of the glass lens and the brushing surface along a brushing path.

Table 1 below compares the properties of the lenses made according to Examples A, B, C, and D, after polarization dye deposition and stabilization. In these examples, the lens substrates were colored, and the mean transmission of the lens substrates (uncoated lens) was 43.5%. From the examples, it appears that brushing in a continuous manner (as in Example D) rather than in portions or going over a previously brushed area (as in Example C) results in a more uniform polarizing layer, maintaining the polarization efficiency and haze level.

TABLE 1

| | Exam- | | | |
|---|---|---|---|---|
| | ple A | | | |
| | (prior | Exam- | Exam- | Exam- |
| Property | art) | ple B | ple C | ple D |
| Polarization | good | partially not | two polarizing | good |
| homogeneity over the | | polarizing | zones linked | |
| entire lens surface | | | by a defect | |
| | | | zone | |
| ASTM haze (%) at | 0.35 | 0.35 | 0.37 | 0.37 |
| the center of the lens | | | | |
| Mean transmission of | 12.9 | 12.9 | 13.1 | 13.0 |
| coated lens (%) at the | | | | |
| center of the lens | | | | |
| Mean transmission of | 29.6 | 29.6 | 30.1 | 29.9 |
| coating (%) at the | | | | |
| center of the lens | | | | |
| Polarization | 99.4 | 99.4 | 99.6 | 99.4 |
| efficiency (%) at the | | | | |
| center of the lens | | | | |

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of preparing a polarizing dye receiving surface, comprising:
bringing the polarizing dye receiving surface into contact with a brushing surface of a brush pad carrying an abrasive material;
brushing the polarizing dye receiving surface with the brushing surface in one or more brushing strokes, each brushing stroke comprising effecting a unidirectional relative motion between the polarizing dye receiving surface and the brushing surface along a brushing path; and
separating the polarizing dye receiving surface from the brushing surface after the brushing.

2. The method of claim 1, further comprising rotating the brush pad during each brushing stroke so that different areas of the brushing surface contact the polarizing dye receiving surface during each brushing stroke.

3. The method of claim 2, further comprising completely brushing the polarizing dye receiving surface with the brushing surface during each brushing stroke.

4. The method of claim 3, further comprising biasing the polarizing dye receiving surface against the brushing surface with a force.

5. The method of claim 4, wherein the brushing surface locally conforms to the polarizing dye receiving surface in response to the force.

6. The method of claim 5, wherein the polarizing dye receiving surface is a convex surface and the brushing surface is a concave surface, the concave surface having a radius of curvature that is greater than or equal to that of the convex surface.

7. The method of claim 5, wherein the polarizing dye receiving surface is a concave surface and the brushing surface is a convex surface, the convex surface having a radius of curvature that is less than or equal to that of the concave surface.

8. The method of claim 1, wherein the polarizing dye receiving surface is a planar surface and the brushing surface is a planar surface.

9. The method of claim 2, wherein the brushing path is a circular path.

10. The method of claim 2, wherein the brushing path is defined by the profile of the polarizing dye receiving surface.

11. The method of claim 2, further comprising dipping or soaking the brushing surface in a slurry comprising water and the abrasive material in powder form.

12. A method of making a polarizing article, comprising:
bringing a polarizing dye receiving surface into contact with a brushing surface of the brush pad carrying an abrasive material;
brushing the polarizing dye receiving surface with the brush surface of the brushing pad in one or more brushing strokes, each brushing stroke comprising effecting a unidirectional relative motion between the polarizing dye receiving surface and the brushing surface of the brushing pad along a brushing path;
separating the polarizing dye receiving surface from the brushing surface; and
depositing a polarizing dye on the polarizing dye receiving surface.

13. The method of claim 12, further comprising rotating the brush pad during each brushing stroke so that different areas of the brushing surface contact the polarizing dye receiving during each brushing stroke.

14. The method of claim 13, wherein the polarizing dye is a liquid crystal compound.

15. The method of claim 13, further comprising washing the polarizing dye receiving surface to remove the abrasive material from the polarizing dye receiving surface prior to depositing the polarizing dye on the polarizing dye receiving surface.

16. The method of claim 13, wherein the polarizing dye receiving surface is a curved surface.

17. The method of claim 13, wherein the polarizing dye receiving surface is a convex surface and the brushing surface is a concave surface.

18. The method of claim 13, wherein the polarizing dye receiving surface is a concave surface and the brushing surface is a convex surface.

19. The method of claim 13, wherein the brushing path is a circular path.

20. The method of claim 13, wherein the brushing path is defined by the profile of the polarizing dye receiving surface.

21. The method of claim 13, wherein the polarizing dye receiving surface is a surface of an ophthalmic or a sunglass lens.

22. The method of claim 21, wherein the polarizing dye receiving surface is a spherical, or aspherical, or progressive, or cylindrical surface.

23. An apparatus for brushing a polarizing dye receiving surface, comprising:
a brush pad having a brushing surface, the brush pad carrying or capable of carrying an abrasive material;
a holder having a surface for supporting the polarizing dye receiving surface;
a positioning device coupled to at least one of the brush pad and the holder to selectively position the holder adjacent to the brush pad;
a first driver coupled to the brush pad, the first driver being configured to rotate the brush pad so that different areas of the brushing surface can be positioned adjacent to the holder; and
a second driver coupled to the holder, the second driver being configured to move the holder in order to effect a relative motion between the holder and the brushing surface along a brushing path.

24. The apparatus of claim 23, wherein the second driver is configured to rotate the holder in order to effect the relative motion.

25. The apparatus of claim 23, wherein the brushing surface has a profile selected from the group consisting of a convex profile, a flat profile, and a concave profile.
